(19) United States
(12) Patent Application Publication
(10) Pub. No.: US 2017/0334179 A1
(43) Pub. Date: Nov. 23, 2017

(54) REFLECTIVE AND HIGH VISIBILITY MATERIALS, INCLUDING MESH LAYER

(71) Applicant: SI Jacobson Mfg. Co. Inc., Waukegan, IL (US)

(72) Inventors: Derek Crenshaw, Waukegan, IL (US); Terry Tank, Waukegan, IL (US); Mike Kim, Waukegan, IL (US)

(21) Appl. No.: 15/603,173

(22) Filed: May 23, 2017

Related U.S. Application Data
(60) Provisional application No. 62/340,431, filed on May 23, 2016.
(60) Provisional application No. 62/394,563, filed on Sep. 14, 2016.

(51) Int. Cl. B32B 27/12; B32B 5/26; B32B 5/02

(52) U.S. Cl. CPC B32B 27/12; B32B 5/026; B32B 5/26; B32B 5/024; B32B 2307/412; B32B 2307/414; B32B 2307/416; B32B 2255/02

(57) ABSTRACT

A retroreflective material that includes a base layer formed of a mesh material, and a retroreflective material layer superposed upon the base layer. Also, a retroreflective laminated material that includes a first layer consisting of a transparent or translucent material; a second layer; and a third layer consisting of an opaque material. The first, second and third layers are laminated together, with the second layer located between the first and third layers. Additionally, the second layer is textured and/or patterned and includes a retroreflective material on an outer surface thereof. In preferred embodiments, the end user of the resulting material, or other person(s), can visibly see the materials that make up a least some of the layers of the laminated material.

### PRIORITY CLAIM

The present application claims priority to U.S. Provisional Application Ser. No. 62/340,431, filed on May 23, 2016, and to U.S. Provisional Application Ser. No. 62/394,563, filed on Sep. 14, 2016, both of which are hereby incorporated by reference in their entirety.

### PURPOSES

To create a mesh material, which is reflective, for the construction, utility, industrial, consumer or commercial markets. The material can stand alone as a reflective mesh (FIG. 1), or it can be included in a triple laminating process resulting in a triple laminated material (FIG. 2), where the mesh layer is captured between two other layers of material.

To create a material for the construction, utility, industrial, consumer or commercial markets, that has high visibility while in use.

To create a material that the end user, or other person(s), can visibly see the materials that make up a least some of the layers of the laminated material.

To arrive at a process for creating the material(s) of the present invention including a laminating process, combining three materials together, to provide a material that person(s) can see each of the three separate layers together, as well as a similar process involving two separate layers, or more than three separate layers.

### BRIEF DESCRIPTION OF THE DRAWINGS

FIG. 1 is an exploded schematic of a first version of the material of the present invention, which includes a first layer of retroreflective material, which may be a woven or knit mesh layer (or may be a coating upon a base layer), and a second layer as the base layer comprising a woven or knit mesh layer, which could be either a retroreflective layer or a non-retroreflective layer;

FIG. 2 is an exploded schematic of a second version of the material of the present invention, which includes a first layer (or top layer) that consists of, for example, a clear layer, a second layer (or middle layer) that consists of, for example, a mesh reflective layer, and a third layer (or base layer) that consists of a reflective or highly visible florescent material;

FIG. 3 is a photograph of an embodiment of the material of the type shown in FIG. 1, shown with reflection;

FIG. 4 is a photograph of an embodiment of the material of the type shown in FIG. 1, shown with no added light; and

FIG. 5 is a photograph of an embodiment of the material of the type shown in FIG. 5, where the middle layer and base layer of colors that are easy to visually differentiate from each other (such as high visibility yellow and orange, high visibility yellow and most other colors; high visibility orange and most other colors, a florescent color and a different florescent or non-florescent color, etc.).

### DETAILED DESCRIPTION

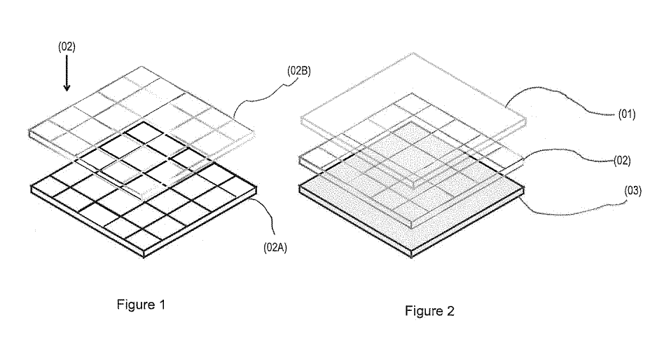

The present invention results in either of two types of materials: (i) a material that is the result of a retroreflective process that creates a mesh material that is reflective (such as in FIG. 1) in which a retroreflective process is performed on top of a mesh material, where the mesh material is preferably a woven or a knit mesh material; or (ii) a three-layer version (FIG. 2) in which the material of FIG. 1 is sandwiched between an inner layer and an outer layer. More details of these two versions are provided below.

### First Version (FIGS. 1, 3 and 4):

The first version of the material (02), as shown in FIG. 1, is the result of the application of a retroreflective material (02B) upon a mesh material layer (02A). The mesh material layer (02A) is textured and/or patterned, and may optionally include a plurality of openings therein that are arranged in a regular or irregular pattern. The retroreflective material (02B) may be applied to the mesh material layer (02A) by any desired method, for example, such as spraying, gluing, coating or painting. Alternatively, two separate mesh layers, (02A) and (02B), may be attached together, where at least layer (02B) has retroreflective properties.

Layer (02A) may be formed of a woven mesh or knit mesh material, or other material including openings therein, preferably with high visibility or fluorescent feature, and it may be comprised of any desired material, such as vinyl, PVC (polyvinyl chloride), PU (polyurethane), TPU (thermoplastic polyurethane) or PEVA (polyethylene vinyl acetate), fabric, metal, etc.

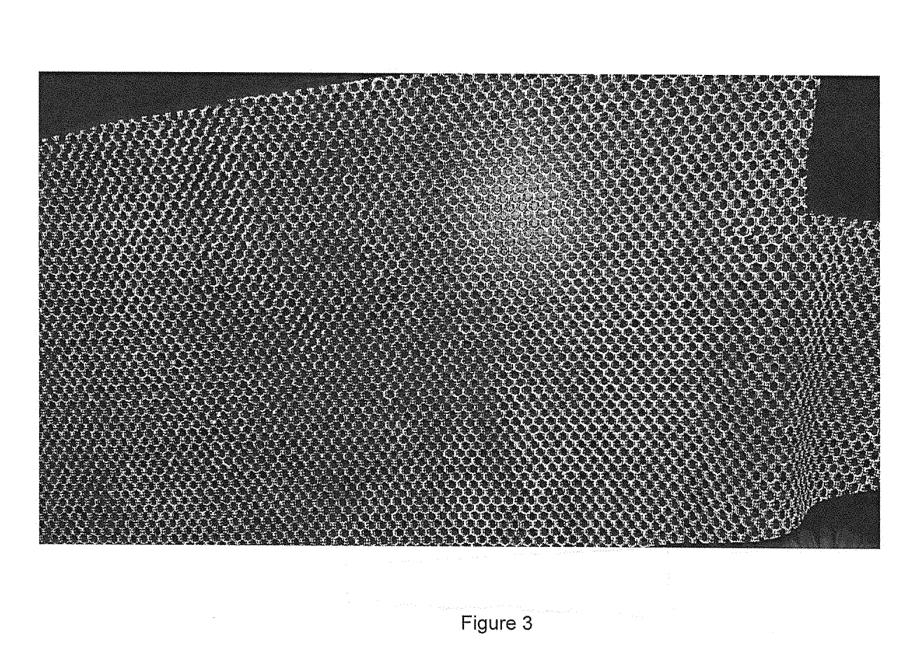

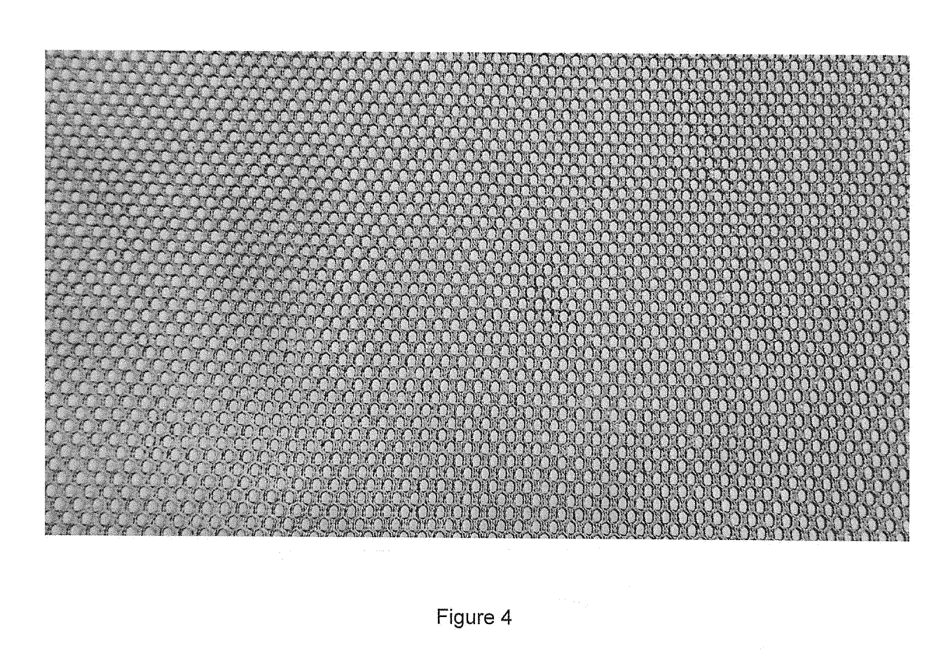

FIG. 3 is a photograph of the material (02) of FIG. 1, showing how it reflects the light; and FIG. 4 is a photograph of the material (02) of FIG. 1, in a state in which no reflective light is being applied.

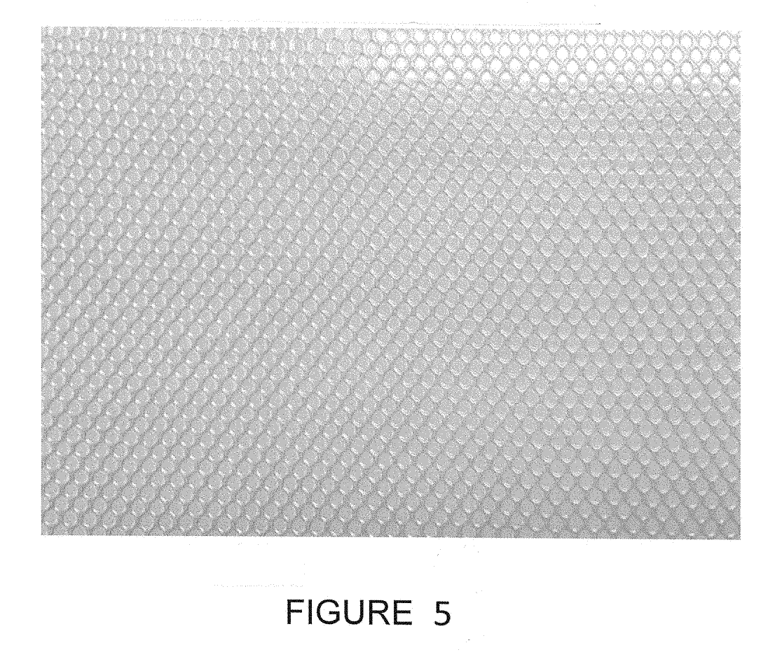

### Three Layer Version (FIGS. 2 and 5):

Layer (01) is a transparent layer (outer layer) which may be formed of any desired material, such as clear, transparent or translucent versions of any of the following materials: vinyl, PVC (polyvinyl chloride), PU (polyurethane), TPU (thermoplastic polyurethane) or PEVA (polyethylene vinyl acetate).

Layer (02) is the middle layer, and it may be formed of a reflective woven mesh material or a knit mesh material. Preferably, layer (02) is formed from the same process and comprises the same layer (02) described above with respect to FIG. 1, although other embodiments are contemplated.

Layer (03) is the base layer (or inner layer), and it may be formed of any desired opaque material, such as opaque versions of any of the following materials: vinyl, (polyvinyl chloride), PU (polyurethane), TPU (thermoplastic polyurethane) or PEVA (polyethylene vinyl acetate). Additionally, layer (03) may be a reflective material, a retroreflective material or a screen print reflective material. In certain embodiments, the material of layer (03) includes a high visibility feature (such as a bright color) and/or a fluorescent feature.

Descriptions of some examples of materials available for the present invention are provided below.

Thermoplastic polyurethane (TPU) is any of a class of polyurethane plastics with many properties, including elasticity, transparency, and resistance to oil, grease and abrasion. Technically, they are thermoplastic elastomers consisting of linear segmented block-copolymers composed of hard and soft segments.

Polyurethane (PUR and PU) is a polymer composed of organic units joined by carbamate (urethane) links. While most polyurethanes are thermosetting polymers that do not melt when heated, thermoplastic polyurethanes are also available for use in the present invention.

Polyurethane polymers are traditionally and most commonly formed by reacting a di- or poly-isocyanate with a polyol. Both the isocyanates and polyols used to make polyurethanes contain, on average, two or more functional groups per molecule.

Some noteworthy recent efforts have been dedicated to minimizing the use of isocyanates to synthesize polyurethanes, because the isocyanates raise severe toxicity issues. Non-isocyanate based polyurethanes (NIPUs) have recently been developed as a new class of polyurethane polymers to mitigate health and environmental concerns.

Polyurethane products often are simply called “urethanes,” but should not be confused with ethyl carbamate, which is also called urethane. Polyurethanes neither contain nor are produced from ethyl carbamate.

Polyurethanes are used in the manufacture of high-resilience foam seating, rigid foam insulation panels, microcellular foam seals and gaskets, durable elastomeric wheels and tires (such as roller coaster, escalator, shopping cart, elevator, and skateboard wheels), automotive suspension bushings, electrical potting compounds, high performance adhesives, surface coatings and surface sealants, synthetic fibers (e.g., Spandex), carpet underlay, hard-plastic parts (e.g., for electronic instruments), condoms, and hoses. Polyvinyl chloride, more correctly but unusually poly (vinyl chloride), commonly abbreviated PVC, is the world's third-most widely produced synthetic plastic polymer, after polyethylene and polypropylene.

PVC comes in two basic forms: rigid (sometimes abbreviated as RPVC) and flexible. The rigid for of PVC is used in construction for pipe and in profile applications such as doors and windows. It is also used for bottles, other non-food packaging, and cards (such as bank or membership cards). It can be made softer and more flexible by the addition of plasticizers, the most widely used being phthalates. In this form, it is also used in plumbing, electrical cable insulation, imitation leather, signage, inflatable products, and many applications where it replaces rubber.

Pure poly (vinyl chloride) is a white, brittle solid. It is insoluble in alcohol but slightly soluble in tetrahydrofuran. PEVA is a nontoxic vinyl (it does not have the chlorine molecule that makes PVC toxic). EVA is Ethylene vinyl acetate, a copolymer of ethylene and vinyl acetate.

Preferably, the colors and/or patterns of the various layers are different from each other to highlight the visual difference between the layers. In some embodiments, layer (03) is formed of a bright color, such as yellow or orange, and/or of a fluorescent color.

Preferably, layer (01) is transparent, or at least translucent, to permit layers (02) and (03) to be visible when the triple (or multi-layer) laminated material is viewed from the layer (01) side. It is contemplated that layer (01) could be tinted with a color, especially a color that is lighter than the color(s) of layers (02) and (03).

Preferably layer (02) is textured and/or patterned and preferably includes a plurality of openings therein arranged in a regular or irregular pattern, such that at least a portion of layer (03) is visible when the triple laminated material is viewed from the layer (01) side.

Preferably, the layers of the laminated material are permanently assembled together to form a laminated structure by heat, pressure, welding, and/or adhesives.

It is also contemplated that the laminated material of FIG. 2 could be comprised of more than three layers, with at least two layers being visible.

1. A retroreflective material comprising:
a base layer comprising a mesh material; and
a retroreflective material layer superposed upon the base layer.

2. A retroreflective laminated material comprising:
a first layer consisting of a transparent or translucent material;
a second layer; and
a third layer consisting of an opaque material,
wherein the first, second and third layers are laminated together, with the second layer located between the first and third layers, and
wherein the second layer is textured and/or patterned and includes a retroreflective material on an outer surface thereof.

3. A high visibility laminated material comprising:
a first layer consisting of a transparent or translucent material;
a second layer; and
a third layer consisting of an opaque material,
wherein the first, second and third layers are laminated together, with the second layer located between the first and third layers, and
wherein the second layer is textured and/or patterned and includes a plurality of openings therein.

3. The visibility laminated material of claim 3, wherein at least a portion of the third layer is visible when the high visibility laminated material is viewed from the first layer side.
